(19) United States
(12) Patent Application Publication
(10) Pub. No.: US 2014/0263015 A1
(43) Pub. Date: Sep. 18, 2014

(54) APPARATUS AND METHOD FOR MAGNETICALLY TREATING FLUIDS

(71) Applicant: SPINFLIP LLC, BROOKLYN, NY (US)

(72) Inventors: ROBERT EASTWOOD COX, HUNTINGTON, NY (US); OLIVER HAMILTON BODINE, HUNTINGTON, NY (US); WILLIAM BRINTON COX, HALIFAX (CA)

(73) Assignee: SPINFLIP LLC, BROOKLYN, NY (US)

(21) Appl. No.: 14/180,360

(22) Filed: Feb. 14, 2014

Related U.S. Application Data
(60) Provisional application No. 61/791,940, filed on Mar. 15, 2013.

(51) Int. Cl. B03C 1/02

(52) U.S. Cl. CPC B03C 1/02
USPC 210/222

(57) ABSTRACT

An apparatus and methodology is presented for magnetically conditioning any fluid or gas transported through a conduit, pipe or by other means. The object of the invention is to advance the art by increasing the range of application, the effectiveness, simplicity and ease of use of a magnetic fluid conditioning device. The invention accomplishes this by a unique magnetic and mechanical configuration, not taught in the art or previously known to the applicants.

### CROSS REFERENCE TO RELATED APPLICATIONS

The present application claims the benefit of U.S. Provisional Application 61/791,940 filed Mar. 15, 2013.

### FIELD OF THE INVENTION

The field of the present invention generally relates to magnetically conditioning fluids or gases.

### BACKGROUND OF THE INVENTION

Magnetic water conditioning devices have been used as early as the 1950s (Vermeiren U.S. Pat. No. 2,652,925) for conditioning water in an effort to prevent scale build up and minimize the damaging effects of hard water on pipes. Municipal water supplies and other commonly available water sources often contain a variety of mineral components including, calcium carbonate and other mineral compounds which can precipitate out of solution and aggregate to form scales on pipe walls thereby restricting flow and causing corrosive damage. Mineral aggregation on a pipe wall can provide a matrix for the accumulation of algae and other organisms which can further damage pipes due to biologic corrosion. The molecular chemistry of these processes is often complex and not always well understood as myriad variables, such as water borne chemicals and biologic constituents, may vary considerably depending on location and the specific application.

However, it is generally recognized that when an aqueous media, such as municipal water, passes through a magnetic field electric currents and charges are induced that affect free ions in the water (Patterson U.S. Pat. No. 6,171,504), placing a negative electric charge on the conduit or pipe (Clair U.S. Pat. No. 5,366,623) repelling particulates and ions suspended in the water which also tend to be negatively charged—referred to as “pipe charging” (1-15). This process prevents mineral aggregation on the conduit walls via a number of electro-chemical mechanisms including encouraging the formation of microscopic crystallization nuclei leading to the seeding of minerals which are then unavailable for aggregation on vessel walls (Kronenberg, Experimental Evidence for the Effects of Magnetic Fields on Moving Water, and (Schoepe U.S. Pat. No. 5,378,362 5-25). Early approaches to magnetic water conditioning did find limited success, but have since given way to more studied approaches and sophisticated devices that have gained wider acceptance not only for domestic water conditioning, but for numerous industrial applications, such as the prevention of mineral incrustation of large boilers. More recently, applications for magnetic fluid conditioning devices have extended to gasses and other liquids, such as hydrocarbon oils and fuels. For example, magnetic conditioners are now employed widely in the oil industry as a lower cost alternative to harsh and toxic chemicals used to mitigate paraffin buildup in oil pumps and oil pipes and managing the corrosion by-product of heavily mineralized water that is often present in oil production (Guo et al).

Magnetic conditioning devices are also used for treating fuel oil for heating plants and are marketed for treating gasoline and diesel fuel for which application they are reported to increase fuel efficiency and reduce the exhaust emissions in internal combustion engines and other hydrocarbon burning devices. The magnetic treatment devices are positioned either internal to a fuel conduit or externally mounted on a fuel conduit. A wide variety of designs have been employed to treat liquid hydrocarbon fuels that purport to ionize, de-clump, or unfold hydrocarbon chains and reduce fuel viscosity thereby affording a greater surface fuel area and greater number of molecular oxidation sites improving combustion efficiency and lowering particulate emissions and noxious gas emissions (Fujita U.S. Pat. No. 4,188,296). Sacs (EP1587761 A1) and Twardzic (U.S. Pat. No. 5,558,765) teach the mechanism of “spinflip” in which valence electrons in atoms as part of a larger molecular structures, will absorb a precise amount of electromagnetic energy and realign (flip) in the direction of an imposed magnetic field and will seek equilibrium by assuming a new configuration within the molecule. This is held to produce an unclumping of hydrocarbon molecules and an unfolding and separation of the hydrocarbon molecular chains. Tao (US 20120228205) reported a direct correlation between the magnetic treatment of hydrocarbon fuel and a reduction in fuel viscosity. Guo et al also noted a decrease in viscosity and also a reduction in hydrocarbon surface tension after the application of a magnetic field. Similarly, Fujita U.S. Pat. No. 4,188,296 states that hydrocarbons passing through magnetic flux reorient and shift their structure, which in addition, considerably weaken or depress van der Waal forces, helping to disperse hydrocarbon molecules. Van der Waal forces are the net attractive and repulsive intermolecular forces. Fujita further demonstrates fuel treatment optimization for his device by showing magnetic flux strength versus post combustion particulate emissions and mono-nitrogen oxides (NOx) content of the exhaust gas. It is interesting to note that Fujita's data shows Gaussian strength sweet spots for fuel treatment optimization in the range of from 1600 to 2300 Gauss for his device. This strongly suggests that there are preferential magnetic strength “windows” that supply the “right” level of magnetic energy stimulus necessary to alter the hydrocarbon molecule configuration for a given fuel and fuel transport parameter. According to R. Kita reporting in Infinite Energy Issue 83 January/February 2009, in referring to Fujita's data in the magnetic treatment of hydrocarbon fuels (U.S. Pat. No. 4,188,296); “What is not understood by many is that the effect is non-linear, which means that too high a magnetic field results in a diminished effect . . . it seems like the series of waves relate that a quantum effect is occurring. Many times in science proportionality is assumed, and in this case the effect is non-linear and discrete levels of gauss must be used to achieve positive results.”

It is evident from the foregoing discussion that there is a multiplicity of electric and magnetic mechanisms at work in treating different fluids with a magnetic field, requiring the application of the appropriate level of magnetic stimulus. In more electrically conductive fluids, particularly aqueous fluids, electric currents induced by magnetic fields play a larger roll in modifying the fluid transporting environment and in ionizing various particles, minerals and promoting the seeding of mineral crystals. Whereas in fluids, such as hydrocarbons, different changes occur on an atomic and molecular level. The magnetic treatment of these fluids is optimized with the application of an appropriate level of quantum stimulus energy i.e., magnetic field intensity and magnetic vector.

Clair U.S. Pat. No. 5,269,916 teaches that an optimal water conditioning effect is achieved when fluid passes through a magnetic field that is orthogonal to the flow of said fluid which comports with Faraday's Law. The resulting induced electrical current imposes a negative charge on a pipe wall which repels mineral ions and other particles that also tend to be negatively charged. In the water conditioning industry this is referred to as “pipe charging”. In U.S. Pat. No. 5,366,623 Clair employs a plurality of 12,000 Gauss neodymium iron boron permanent magnets and flux concentrator pieces arranged circumferentially about a fluid conduit. The magnetic poles alternate so that a N pole is always adjacent to a S pole ensuring that the magnetic flux passes through the fluid conduit or pipe entirely orthogonal (2-5) to the fluid flow in order to impart the maximum electric charge to a conduit or pipe to prevent corrosion, scaling, algae or other forms of aggregation on a pipe wall. The apparatus produces a magnetic field that is exclusively orthogonal to treated fluid. It is a complex assembly comprising many parts and adding significant bulk to the fluid conduit.

Prior art in Riera U.S. Pat. No. 7,445,694 shows that when treating hydrocarbon fuels, it is useful to subject the fluid flow to multiple, dynamic magnetic field vectors to induce stereochemical molecular deformation. This results in shifting a hydrocarbon fuel's outer valence electrons to a higher energy state, thereby imposing polarizing electric and magnetic forces on the molecule's structure which tends to unfold and straighten out the hydrocarbon molecule chains exposing many more oxidation sites for increased combustion efficiency. Riera uses a complex arrangement of electromagnets and permanent magnets and driver electronics, which subjects the fuel to a plethora of magnetic field vectors varying in strength, direction and frequency in order to provide stimulus energies for inducing molecular deformation The Riera apparatus is complex requiring expensive electronic driver circuitry and electronic frequency source for the electromagnets which may prohibit its use for most simpler applications such as fuel conditioning for a passenger car or conditioning a domestic water supply.

Still another approach to magnetically treat fluid such as hydrocarbon fuels and water is shown by Glass U.S. Pat. No. 6,056,872. It employs like pole, juxtaposing permanent magnets i.e., S-S or N-N, arranged axially along a fluid conduit which the inventor claims to produce predominantly orthogonal lines of magnetic flux lines that pass through the fluid conduit. However, in Figures of the '872 patent magnetic flux lines bend away from the juxtaposed like, S pole magnet faces at curved angles (2-45) and do not to appear to be orthogonal. A major deficiency in employing juxtaposed, like pole magnets in this manner is that it produces areas devoid of magnetic flux by mutual repulsion wherein fluid in these areas remains untreated. In an attempt to remedy this problem, (3-25) juxtaposed S only magnet poles each facing into the fluid conduit which are varied in combination of magnet strength and or size and or magnet to magnet spacing in an attempt to offset the spatial position of the flux void produced by each magnet grouping. This would seemingly eliminate a contiguous flux void that would otherwise run the length of the fuel treatment apparatus and allow a significant percentage of the fuel to exit untreated. Glass, in offsetting the flux void areas away from the axis of fuel flow, potentially leaves a significant portion of the fluid treatment area devoid of magnetic flux or flux that is not orthogonal to the flow of fluid as asserted in the patent.

Schoepe U.S. Pat. No. 5,378,362 offers another approach to the magnetic treatment of fluids wherein two groups of opposite pole, juxtaposed magnet pairs are placed axially on the periphery of the fluid conduit. Each magnet pair within a group is separated by paramagnetic spacers of equal thickness. The spacing between the magnets within the first group has a dimensional relationship with the spacing between the magnets of the second group so that the magnet spacing in the second group exceeds the magnet spacing in the first group by at least 5% of a whole number multiple of the first group. Schoepe refers to this as non-harmonic spacing and asserts that the magnet spacing promotes a stimulating resonant effect acting on the oscillatory nature fluid particles in water. However, any resonant stimulating effect is also dependent on the velocity of the fluid through the conduit and this device only proposes two resonant points which leaves open the possibility of resonances outside the range of the two magnet groups.

Fujita U.S. Pat. No. 4,188,296 presents a magnetic device for treating fluid fuel in which a plurality of juxtaposed N and S magnet poles are mounted in a magnetically permeable yoke surrounding a fuel conduit. The magnet faces adjacent and orthogonal to the fuel conduit are adjustable to alter the strength of the magnetic flux passing through the fuel, hence giving ability to optimize the efficiency of the fuel treatment. Fujita demonstrated optimal adjustment points, between the maximum and minimum magnetic flux strength.

### SUMMARY OF THE INVENTION

In the present invention, the apparatus is comprised of a two part, high permeability magnetic housing/shield and a plurality of juxtaposed permanent magnets that is easily slid over a conduit or pipe. The magnets are positioned in a non-linear progressive pattern which subjects the fluid or gas being transported to a broad spectrum of magnetic flux in terms of flux intensity, flux direction and flux induced oscillations which enhances the combustion properties of a fuel and minimizes the aggregation of organic and mineral solids in aqueous fluids or hydrocarbon fluids on the transporting vessel walls.

The prior art has shown various apparatus and methods for treating fluids and gasses. It is well established that the principal method to magnetically treat aqueous fluids is to impart a large negative electric charge to pipe walls thereby repelling and suspending in solution negatively charged mineral ions and particles that may otherwise aggregate and clog a pipe or conduit. Apparatus in the prior art generally employ strong magnetic fields which they attempt to pass, exclusively or mostly, orthogonally through the moving aqueous fluid to achieve a maximum induced electric current and the maximum negative charge on the pipe wall. However, when treating a broader range of fluids from highly conductive aqueous fluids, to more dielectric fluids and viscous hydrocarbon fuels and oils, it is posited that imposing a magnetic field exclusively orthogonal to the axis of fluid flow does not adequately access or stimulate hydrocarbon molecules that are randomly oriented, folded and clumped and bound by van der Waal forces. Bear in mind that, collectively, atomic electrons, particularly hydrogen electrons, within a hydrocarbon's molecular structure have a magnetic moment which is more or less randomly oriented. To produce a maximum response or “spinflip” and align the valence electrons to an externally imposed magnetic field, it must be stimulated by the “right” magnetic vector gradient. For example, for Hydrogen atoms within the hydrocarbon molecules which are spinflipped converting them from a parahydrogen state to an orthohydrogen state which reacts much more efficiently during combustion (Ruskin U.S. Pat. No. 3,228,868).

The inventors contend that the precise strength of the magnetic field is only one component of the “right” stimulative energy, the other factor being the vector angle of the magnetic field with respect to an electrons magnetic moment. One might think of clumped hydrocarbon molecules as analogous to a tangled bunch of sticky string which must be untangled to expose more surface area for efficient combustion. Shaking the string in different directions at different amplitudes and at different rates would help to loosen and untangle the string so that it could be shaken out straight.

The invention employs a similar concept by subjecting a flowing hydrocarbon fluid to a magnetic field spectrum which varies in strength, flux direction and periodicity of the magnetic impulse, induced by the rate at which fluid flows through the magnetic field. The variability of these factors in one embodiment of the invention is produced by a non-harmonic spacing of juxtaposed magnets arranged in a progressive, nonlinear pattern. One such pattern is derived from the well known Fibonacci sequence. Magnet pairs arranged in such a manner are mounted peripherally on a fluid conduit which provides a gauntlet of magnetic fields through which the fluid must pass. The invention imposes the magnetic field through the flowing fluid which reverses in polarity at progressively increasing or decreasing rates (depending on the distance between adjacent magnets), and varies magnetic flux strength due to reinforcement and interference of the magnetic fields between adjacent and juxtaposed magnet poles.

The aperiodic imposition of magnetic pulses on a fluid also stimulates destructive resonant forces on particles and agglomerated impurities contained within a fluid which has been shown to be effective in water treatment (Schoepe U.S. Pat. No. 5,378,362 4-10). In one embodiment of the present invention, the Unit is positioned on the conduit so that the flow enters the Unit where the magnets are proximally spaced and exits the Unit where the magnets are more distally spaced. At the fluid entry point this configuration provides more diverse magnetic flux vectors and range of flux intensities to more fully match the spinflip energy “window” within a hydrocarbon molecular structure. The mid-section magnets provide decreasing periodicity of pole reversals and the last, more isolated magnet stage presents a stronger, mostly orthogonal magnetic field to the exiting fluid which completes the straightening and alignment of hydrocarbon molecules and induces greater electric current in aqueous fluids.

The present invention produces a spectrum of magnetic field intensities, magnetic vectors and induced frequencies which expose treated fluids to a smorgasbord of magnetic forces allowing the appropriate quantum excitation energy and frequency to effect the most efficient fluid treatment process for any particular application.

### BRIEF DESCRIPTION OF THE DRAWINGS

Preferred and alternative examples of the present invention are described in detail below with reference to the following Figure drawings:

FIG. 1 is a perspective rendering that shows the fluid conditioning unit installed on a fluid carrying pipe;

FIG. 2 is an end view of a fluid conditioning Unit installed on a pipe;

FIG. 3 is an end view of a fluid conditioning Unit prior to mating over a pipe;

FIG. 4 is a view looking into a fluid conditioning Unit half 3 from the top of the “U” channel;

FIG. 5 is a view looking into a fluid conditioning Unit half 2 from the top of the “U” channel;

FIG. 6 is a side view of the wider Unit half 3 showing one example of magnet positions;

FIG. 7 is an end view of a fluid conditioning Unit featuring a flux diverter plate;

FIG. 8 is a side view of a fluid conditioning Unit featuring a flux diverter plate, as in FIG. 7;

FIG. 9 is a side cross-section view of a fluid conditioning Unit featuring a flux diverter plate, as in FIG. 8.

### DETAILED DESCRIPTION

The invention apparatus shown in FIG. 1 is a magnetic conditioning device which is peripherally attached to a conduit or pipe FIG. 2 1 through which any gas or fluids may flow. The invention comprises two U shape metal channels, forming Unit half 2 and Unit half 3, that are made of a high permeability magnetic material, such as soft iron or cold rolled steel. The thickness of such material is sufficient to provide a low reluctance magnetic circuit and magnetically shield the Unit which increases the efficiency of the invention and minimizes the potential for stray fields which affect other magnetically sensitive devices. The widths of unit half 2 and unit half 3 are slightly different so that the smaller part 2 will vertically slide fit 13 into the larger part 3 with a minimal air gap between the intersecting walls 12 forming a contiguous magnetic shield and a complete magnetic circuit. By nature of the sliding fit, the engagement of Unit halves 2,3 are adjustable, easily permitting the capture of a wide range of conduit sizes 6 while maintaining contact 11 between the magnet faces and the fluid conduit ensuring no loss in magnetic flux density in the fluid or gas. Unit halves 2 and 3 are shown prior to installation over a conduit in FIG. 3. The Unit halves, when mated about a conduit, are held together by magnetic attraction; however, additional securing devices such as zip ties or duct tape may also be used for additional security (not shown in the Figures).

A plurality of permanent magnets 4, 5 are mounted on the bottom of each unit half 8 using glue or epoxy or by other suitable attachment means. In an embodiment of the invention five magnets are located in each Unit half FIG. 4 4, 14 and FIG. 5 5, 15. However, in other embodiments of the invention any number of magnets may be employed. The magnet material may be either a rare earth type, such as NIB (neodymium-iron-boron) or ceramic (ferrite) depending on the characteristics of the fluid or gas being transported and the operating environment i.e., the ambient temperature must be well below the Curie temperature (demagnetizing temperature) of the magnets. Each magnet expresses a single magnetic pole on its face 7 one of which is coplanar with the fluid conduit 1 and a single magnetic pole on its opposite face which is coplanar with the inside bottom of each unit half 8. In one embodiment all the magnets in a given Unit are identical in strength and can range from 500 to 13,000 Gauss. It is not intended to limit applying magnets of unequal strengths in other configurations. The appropriate magnet strength is based on the fluid or gas and conduit characteristics and is determined by empirical testing by one practiced in the art. In an embodiment the magnet shape is rectangular however, the magnet shape may also be rectilinear, cylindrical or any other suitable geometric shape. In an embodiment, the Unit is positioned on the conduit so that the flow enters the Unit where the magnets are proximally spaced and exits the Unit where the magnets are more distally spaced.

Also in an embodiment of the invention the magnet spacing pattern FIG. 4 9, 10, is identical for both channels, such that when the Unit halves 2, 3, are mated about a fluid conduit 1 each magnet in 2 is juxtaposed and aligned to a magnet in 3, and the polarity of each magnet in 2 corresponds to an opposite magnet polarity in 3 i.e., 4 is an N pole and 5 is a S pole. The preferred mating orientation is then; FIG. 4 End A is mated with FIG. 5 End AA.

Also in a further embodiment of the invention the spacing between the magnets 9, 10 can be a progressive non-linear sequence which is determined by the Fibonacci Sequence or the closely related Golden Ratio (1:1.61803). A typical starting value for a Fibonacci Sequence is 1 mm 9 and an end value for the sequence series for spacing between five magnet pairs is 3 mm 10. However, the invention is not limited to those specific values as other non-linear magnet spacing sequences may also be used for different applications. In another example, when the Golden Ratio is used, the spacing between the first magnet and second magnet in channel is 1 unit of measure 9, then the spacing between the second and the third magnets would be 1.618 units of measure, and the third and fourth magnet would be 2.618 units of measure and the fourth and fifth units would be 4.236 units of measure 9, and so forth. In yet another embodiment of the invention spacing between magnets may also be linear. In this case the incremental spacing of the magnets is adjusted to obtain a desired magnetic pattern and frequency of the induced effect on the fluid or gas which is adjusted according to the intended flow rate and/or empirical observation of efficacy.

In another embodiment of the invention, unit halves 2 and 3 may be engaged in reverse, that is to say, when 2 and 3 are mated in this configuration, FIG. 5 End BB would then be aligned with FIG. 4 End AA. causing the juxtaposed magnets in 2 and 3 to be slightly offset axially thereby creating a different magnetic flux pattern which is useful for some applications.

In an additional embodiment shown in FIGS. 7, 8, and 9, the magnets in each channel half 2, 3 are mounted on a magnetically permeable flat bar (flux diverter plate) 18 with an assigned separation between magnets 9, 10. Additionally, a spacer 17 made of any non-magnetic material (typically 0.032 to 0.063 inches thick) is positioned between the outer channel and the flux diverter plate which increases the reluctance of the magnetic circuit to pass through the outer channel. The magnetic saturation level of the diverter plate is directly related to plate thickness and to the magnetic properties of the plate material. For example, with a very thick plate, magnetic saturation will not occur, and all of the flux will be contained within the plate thereby directed to adjacent magnets which are of opposite polarity, whereas with a thin plate, magnetic saturation will occur at a much lower flux level allowing some of the flux to pass directly through the flux diverter plate 18 and the non-magnetic spacer 17 to the outer channel 2, 3 where it is conducted to the mating channel half. Therefore by selecting the proper flux diverter plate thickness and the non-magnetic spacer thickness, one may control the proportion of flux 19 directed to adjacent magnets, the inner magnetic circuit, and the flux 20 which passes through the flux diverter plate to the outer channel completing the outer magnetic circuit. The magnetic field directed by the flux diverter plate alters the proportion of flux which is predominantly orthogonal and the flux which is more axial to the flow in the fluid conduit 1 permitting the further variation and optimization of the flux patterns within the fluid conduit space. In addition, by redirecting a portion of flux away from the outer channel the amount of stray magnetic field outside of the unit is significantly reduced.

The embodiments of the invention in which an exclusive property or privilege is claimed are defined as follows:

1. An apparatus, comprising:
two unit halves; and
one or more magnets attached to at least one of the unit halves; and
wherein fluid or gas flows through a conduit.

2. An apparatus as in claim 1 wherein each of the two unit halves is a U-shaped channel with a base section with a plane between each of two wall sections, such that each wall section forms a right angle to the plane of the base section.

3. An apparatus as in claim 2 wherein the base section the each unit half is a different base width such that walls of the unit half with the smaller base width are operable to slide vertically between the walls of the unit half with the larger base width.

4. An apparatus as in claim 3 wherein the walls of the two unit halves slide vertically leaving an air gap of not more than 2 mm between the intersecting walls of each half.

5. An apparatus as in claim 4 wherein the unit halves are made of a high permeability magnetic material.

6. An apparatus as in claim 5 wherein the high permeability magnetic material is selected from the group consisting of soft iron or cold rolled steel.

7. An apparatus as in claim 6 wherein the one or more magnets attached to the at least one unit half are mounted to one side of a magnetically permeable bar, the bar being further attached to the base section of the unit half.

8. An apparatus as in claim 7 wherein a spacer is interposed between the magnetically permeable bar and the base section of the unit half.

9. An apparatus as in claim 8 wherein the spacer is made of a non-magnetic material.

10. An apparatus as in claim 9 wherein the one or more magnets are oriented to have one pole face coplanar with the conduit.

11. An apparatus as in claim 1 wherein the one or more magnets are attached to both unit halves.

12. An apparatus as in claim 1 wherein the magnets are placed facing on opposing unit halves having opposite pole faces coplanar with the conduit.

13. An apparatus as in claim 1 wherein three or more magnets are attached to the unit halves.

14. An apparatus as in claim 1 wherein four or more magnets are attached to the unit halves.

15. An apparatus as in claim 1 wherein five or more magnets are attached to the unit halves.

16. An apparatus as in claim 13 wherein the spacing pattern between the three or more magnets on a unit half is non-linear.

17. An apparatus as in claim 13 wherein the spacing pattern between the three or more magnets on a unit half follows the Fibonacci Sequence.

18. An apparatus as in claim 13 wherein the spacing pattern between the three or more magnets on a unit half follows the Golden Ratio.

19. An apparatus as in claim 1 wherein the one or more magnets are made of a material having a curie temperature higher than their operating environment.

20. An apparatus as in claim 1 wherein the one or more magnets are made of a magnetic material selected from the group consisting of rare earth, neodium-iron-boron, or ceramic.
